(19) United States
(12) Patent Application Publication
(10) Pub. No.: US 2023/0326238 A1
(43) Pub. Date: Oct. 12, 2023

(54) OPTIMIZATION-BASED PARAMETRIC MODEL FITTING VIA DEEP LEARNING

(71) Applicant: MICROSOFT TECHNOLOGY LICENSING, LLC, Redmond, WA (US)

(72) Inventors: Julien Pascal Christophe VALENTIN, Zurich (CH); Federica BOGO, Kilchberg (CH); Vasileios CHOUTAS, Zurich (CH); Jingjing SHEN, Cambridge (GB)

(21) Appl. No.: 17/719,335

(22) Filed: Apr. 12, 2022

(51) Int. Cl. G06V 40/16

(52) U.S. Cl. CPC G06V 40/165

(57) ABSTRACT

A neural optimizer is disclosed that is easily applicable to different fitting problems, can run at interactive rates without requiring significant efforts, does not require hand crafted priors, carries over information about previous iterations of the solve, controls the learning rate of each parameter independently for robustness and convergence speed, and combines updates from gradient descent and from a method capable of very quickly reducing the fitting energy. A neural fitter estimates the values of the parameters Θ by iteratively updating an initial estimate Θ₀.

### BACKGROUND

Landmark detection is a computer vision task where keypoints of a human face or body (e.g., characteristic points) are detected and localized in images and video. Keypoints can be used, for example, to detect a person's head position and rotation. Landmark detection can be challenging due to variability as well as a number of factors such as pose and occlusions. Many tasks in computer vision require fitting a parametric model to input data. For example, approaches for human body 2D/3D pose estimation, body tracking, and face tracking commonly rely on a parametric model of the human body or face and fit it to noisy input data. Estimating 3D human pose from a head-mounted device is a difficult problem, due to self-occlusions caused by the position of the headset and the sparsity of the input signals.

It is with respect to these considerations and others that the disclosure made herein is presented.

### SUMMARY

In mixed-reality scenarios, fitting algorithms need to run robustly and efficiently on very limited computational budget, which makes the deployment of large deep learning architectures infeasible. Current methods rely on classic optimization which fit the parametric model to data by iteratively minimizing a hand-crafted energy function. However, this has a number of disadvantages: hand-crafted energy functions are difficult to define and to tune (different problems may require the definition of totally different functions); and they cannot fully exploit large amounts of training data as deep learning-based/data-driven approaches currently allow, thus lacking robustness, accuracy, and efficiency with respect to data-driven approaches.

The present disclosure provides a way to combine classic optimization frameworks with deep learning to reap benefits of both worlds. In this way, principled algorithms can be implemented which maintain the structure of classic optimizers, and therefore their generalization capabilities, but make them more accurate, robust and efficient by learning their parameters and the priors from data.

The present disclosure describes ways to use learned-based variants (e.g., in deep neural networks) for various components commonly encountered in classic optimization frameworks:
Computation of gradient descent and Gauss-Newton steps (step direction and length);
Computation of trust regions;
Line search and Wolfe conditions;
Weighting schemes based on attention or other learned mechanisms (for example, attention models mapping from energy function residuals and gradients to model parameter updates).

This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### DRAWINGS

The Detailed Description is described with reference to the accompanying FIGS. In the FIGS., the left-most digit(s) of a reference number identifies the FIG. in which the reference number first appears. The same reference numbers in different FIGS. indicate similar or identical items.

FIG. 1A is a diagram illustrating examples of the disclosed techniques according to one embodiment disclosed herein.

FIG. 1B is a diagram illustrating examples of the disclosed techniques according to one embodiment disclosed herein.

FIG. 2 is a flow diagram showing aspects of an illustrative routine, according to one embodiment disclosed herein.

FIG. 3 is a computer architecture diagram illustrating aspects of an example computer architecture for a computer capable of executing the software components described herein.

FIG. 4 is a computer architecture diagram illustrating aspects of an example computer architecture for a computer capable of executing the software components described herein.

FIG. 5 is a data architecture diagram showing an illustrative example of a computer environment.

### DETAILED DESCRIPTION

Fitting parametric models of human bodies, hands, or faces to sparse input signals in an accurate, robust, and fast manner promises to significantly improve immersion in AR and VR scenarios. A common first step in systems that tackle these problems is to regress the parameters of the parametric model directly from the input data. This approach is fast, robust, and is a good starting point for an iterative minimization algorithm. The latter searches for the minimum of an energy function, typically composed of a data term and priors that encode knowledge about the problem's structure. While this can yield positive results, priors are often hand defined heuristics and finding the right balance between the different terms to achieve high quality results is a non-trivial task. Furthermore, converting and optimizing these systems to run in a performant way requires custom implementations that demand significant time investment from both engineers and domain experts.

Fitting parametric models to noisy input data is a common task in computer vision. Notable examples include fitting 3D body, face, and hands. Direct regression using neural networks is the de facto default tool for estimating model parameters from observations. While the obtained predictions are robust and accurate to some extent, they often fail to tightly fit the observations and require large quantities of annotated data. Classic optimization methods, e.g., the Levenberg-Marquardt algorithm, can tightly fit the parametric model to the data by iteratively minimizing a hand-crafted energy function, but are prone to local minimas and require good starting points for fast convergence. Hence, practitioners typically combine these two approaches to benefit from their complementary strengths, initializing the model parameters from a regressor, followed by energy minimization using a classic optimizer.

Optimization-based model fitting methods have another disadvantage in that they often require hand-crafted energy functions that are difficult to define and non-trivial to tune. Besides the data terms which have clear definitions, each fitting problem effectively requires the definition of their own prior terms and regularization terms. Besides the work required to formulate these terms and train the priors, domain experts need to spend significant amounts of time to balance the effect of each term. Since these priors are often hand-defined or assumed to follow distributions that are tractable/easy to optimize, the resulting fitting energy typically contains biases that can limit the accuracy of the resulting fits.

To obtain the best of both regression using deep learning and classical numerical optimization, the present disclosure utilizes the field of machine learning based continuous optimization. In an embodiment, instead of updating the model parameters using a first or second order model fitter, a network learns to iteratively update the parameters that minimize the target loss, with the added benefit of optimized machine learning (ML) back-ends for fast inference. End-to-end network training removes the need for hand-crafted priors, since the model learns them directly from data.

Based on the properties of the Levenberg-Marquardt and Adam algorithms, the present disclosure extends existing methods with an iterative machine learning solver which (i) keeps information from previous iterations, (ii) controls the learning rate of each variable independently, and (iii) combines updates from gradient descent and from a network that is capable of quickly reducing the fitting energy, for robustness and convergence speed.

Learning to optimize is a field that casts optimization as a learning problem. The goal is to create models that learn to exploit the problem structure, producing faster and more effective energy minimizers. In this way, the need for hand-designed parameter update rules and priors is removed, since the system can learn them directly from the data. This approach has been used for image denoising and depth-from-stereo estimation, rigid motion estimation, view synthesis, joint estimation of motion and scene geometry, non-linear tomographic inversion problem with simulated data, face alignment, and object reconstruction from a single image.

A current parametric model of human faces and a user-assisted method to fit the model to images may allow for the training of neural network regressors that can reliably predict Skinned Multi-Person Linear Model (SMPL) parameters from images and videos. With the introduction of expressive models, current regression approaches can predict the 3D body, face and hands. However, one common issue, present in all regression scenarios, is the misalignment of the predictions and the input data. Thus, they often serve as the initial point for an optimization-based method, which refines the estimated parameters until some convergence criterion is met.

This combination produces systems that are effective, robust, and able to work in real-time and under challenging conditions. These hybrid regression-optimization systems are also effective pseudo annotators for in-the-wild images, where standard capture technologies are not applicable. However, formulating the correct energy terms and finding the right balance between them is a challenging and time-consuming task. Furthermore, adapting the optimizer to run in real-time is a non-trivial operation, even when using well-known algorithms such as the Levenberg-Marquardt algorithm which has a cubic complexity. Thus, explicitly computing the Jacobian is often prohibitive in practice, either in terms of memory or runtime. The most common and practical way to speed up the optimization is to utilize the sparsity of the problem or make certain assumptions to simplify it. Learned optimizers promise to overcome these issues, by learning the parametric model priors directly from the data and taking more aggressive steps, thus converging in fewer iterations.

The present disclosure describes a new update rule, computed as a weighted combination of the gradient descent step and the network update, where their relative weights are a function of the residuals. In an embodiment, an optimizer with an internal memory is used, where an RNN is used to predict the network update and the combination weights. In this way, the network can choose to follow either the gradient or the network direction more, using both the current and past residual values.

In an embodiment, the human body may be represented using SMPL/SMPL+H, a differentiable function that computes mesh vertices M(θ,β)∈R^{V×3}, V=6890, from pose θ and shape β, using standard linear blend skinning (LBS). The 3D joints, J (β), of a kinematic skeleton are computed from the shape parameters. The pose parameters θ∈R^{J×D+3} contain the parent-relative rotations of each joint and the root translation, where D is the dimension of the rotation representation and J is the number of skeleton joints. Rotations may be represented using 6D rotation parameterization, thus θ∈R^{J×6+3}. The world transformation Tⱼ(θ)∈SE(3) of each joint j may be computed by following the transformations of its parents in the kinematic tree: Tⱼ(θ)=Tₚ₍ⱼ₎(θ)*T (θⱼ, Jⱼ(β)), where p(j) is the index of the parent of joint j and T (θⱼ, Jⱼ(β)) is the rigid transformation of joint j relative to its parent. In the following description, variables with a hat denote observed quantities.

Two 3D human body estimation problems are considered for illustrative purposes. 1) fitting a body model to 2D keypoints and 2) inferring the body, including hand articulation, from head and hand signals returned by AR/VR devices.

2D keypoint fitting: The projection is computed of the 3D SMPL joints J with a weak-perspective camera Π with scale s∈R, translation t∈R²: j=Πₒ(J (θ, β), s, t). One goal to estimate SMPL and camera parameters Θ^{B}={θ,β}, K^{B}={s, t}, such that the projected joints j match the detected keypoints D^{B}={ĵ}. Fitting SMPL+H to AR/VR device signals: The following are assumed: 1. the device head tracking system provides a 6-DoF transformation \hat{T}^{H}, that contains the position and orientation of the headset in the world coordinate frame. 2. the device hand tracking system gives us the orientation and position of the left and right wrist, \hat{T}^{L}, \hat{T}^{R}∈SE(3), and the positions of the fingertips \hat{P}_{1, . . . , 5}^{L}, \hat{P}_{1, . . . , 5}^{R}∈ [symbol] ³ in the world coordinate frame, if and when they are in the field of view (FOV) of the head-mounted display (HMD). In order to estimate the SMPL+H parameters that best fit the above observations, the estimated headset position and orientation from the SMPL+H world transformations are computed as T^{H}(Θ)=T^{HMD}Tⱼ_{_{H}}(Θ), where j_{H} is the index of the head joint of SMPL+H. T^{HMD} is a fixed transform from the SMPL+H head joint to the headset, obtained from an offline calibration phase.

Visibility may be represented by ν_{L}, ν_{R}∈{0, 1} for the left and right hand respectively. Two scenarios are examined: 1. full visibility, where the hands are always visible, 2. half-space visibility, where only the area in front of the HMD is visible. Specifically, the points are transformed into the coordinate frame of the headset, using T^{H}. All points with z≥0 are behind the headset and thus invisible.

In summary, the sensor data are:

D^{HMD}={\hat{T}^{H},\hat{T}^{L},\hat{T}^{R},\hat{P}_{1, . . . ,5}^{L},\hat{P}_{1, . . . ,5}^{R},υ_{L},υ^{R}}

The goal is to estimate the parameters Θ^{HMD}={θ}∈R³¹⁵, that best fit D^{HMD}. It is assumed that the body shape β is provided from a separate enrollment step.

The human face is represented using a parametric face model, which may be a blendshape model, with V=7667 vertices, 4 skeleton joints (head, neck and two eyes), with their rotations and translations denoted with θ, identity β∈R²⁵⁶ and expression ψ∈R²³³ blendshapes. The deformed face mesh is obtained with standard linear blend skinning.

For face fitting, a set of mesh vertices is selected as the face landmarks P(θ, ψ, β)∈R^{P×3}, P=669. The input data are the corresponding 2D face landmarks \hat{p}∈ [symbol] ^{P}×2.

For this task, a goal is to estimate translation, joint rotations, expression and identity coefficients Θ^{F}={θ, ψ, β}∈R⁵¹⁶ that best fit the 2D landmarks D^{F}=\hat{p}. It is assumed that the cameras are calibrated and thus have access to the camera intrinsics K. Πₚ(P; K) is the perspective camera projection function used to project the 3D landmarks P onto the image plane.

The data term is a function L^{D}(Θ; D) that measures the discrepancy between the observed inputs D and the parametric model evaluated at the estimated parameters Θ.

At the n-th iteration of the fitting process, both 1) the array R(Θₙ) that contains all the corresponding residuals of the data term L^{D} for the current set of parameters Θₙ, and 2) the gradient gₙ=∇L^{D}(Θₙ) are computed.

Let [symbol] by any metric appropriate for SE(3) and ∥ ∥_{ψ} a robust norm. To compute residuals, the Frobenius norm for [symbol] and ∥ ∥_{ψ} is used. Note that any other norm choice can be made compatible with LM.

Body fitting to 2D keypoints: The re-projection error between the detected joints and those estimated from the model is employed as the data term:

[symbol]

^{D}(Θ^{B};D^{B})= [symbol] −Πₚ( [symbol] (Θ^{B}),K^{B})∥_{ψ}

Here J (Θ^{B}) denotes the “posed” joints.

Body fitting to HMD signals: The discrepancy between the observed data D^{HDM} and the estimated model parameters Θ^{HMD} is measured with the following data term:

[symbol]

^{D}(Θ^{HMD};D^{HMD})= [symbol] \hat{T}^{H},T^{H}(Θ^{HMD}) [symbol] +Σ_{ω∈L,B}ν_{ω}( [symbol] \hat{T}^{ω},T^{ω}(Θ^{HMD}) [symbol] +Σᵢ₌₁⁵ [symbol] \hat{P}ᵢ^{ω}−Pᵢ^{ω}(Θ^{HMD}) [symbol] _{ψ})

Face fitting to 2D landmarks: the re-projection error is used as the data term:

[symbol]

^{D}(Θ^{F};D^{F})= [symbol] \hat{p}−Πₚ( [symbol] (Θ^{F});K^{F}) [symbol] _{ψ}

Levenberg-Marquardt (LM) and Powell's dog leg method (PDL) are examples of popular iterative optimization algorithms used in applications that fit either faces or full human body models to observations. These techniques employ the Gauss-Newton algorithm for both its convergence rate approaching the quadratic regime and its computational efficiency, enabling real-time model fitting applications, e.g., generative face and hand tracking. For robustness, LM and PDL both combine the Gauss-Newton algorithm and gradient descent, leading to implicit and explicit trust region being used when calculating updates, respectively. In LM, the relative contribution of the approximate Hessian and the identity matrix is weighted by a single scalar that is changing over iterations with its value carried over from one iteration to the next.

Based on these algorithms, a novel neural optimizer is disclosed that (a) is easily applicable to different fitting problems, (b) can run at interactive rates without requiring significant efforts, (c) does not require hand crafted priors, (d) carries over information about previous iterations of the solve, (e) controls the learning rate of each parameter independently, (f) for robustness and convergence speed, combines updates from gradient descent and from a method capable of very quickly reducing the fitting energy.

In an embodiment, a neural fitter estimates the values of the parameters Θ by iteratively updating an initial estimate Θ₀ as shown in Algorithm 1.

Algorithm 1 Neural fitting

```
Require: Input data D
  Θ₀ = Φ (D)
  h₀ = Φₕ (D)
  while not converged do
    ΔΘₙ, hₙ ← f ([gₙ₋₁, Θₙ₋₁], D, hₙ₋₁)
    Θₙ ← Θₙ₋₁ + u (ΔΘₙ, gₙ₋₁, Θₙ₋₁)
  end while
```

While the initial estimate Θ₀ obtained from a deep neural network Φ might be sufficiently accurate for some applications, a careful construction of the update rule (u(.) in Alg. 1) leads to significant improvements after only a few iterations. It is not necessary to build the best possible initializer Φ for the fitting tasks at hand. h₀ and hₙ are the hidden states of the optimization process. At the n-th iteration in the loop of Alg. 1, a neural network f is used to predict ΔΘₙ, and then apply the following update rule:

u(ΔΘₙ,gₙ₋₁,Θₙ₋₁)=λΔΘₙ+(−γgₙ₋₁) (4)

λ=f_{λ}( [symbol] (Θₙ₋₁), [symbol] )Θₙ₋₁+ΔΘₙ)),λ∈ [symbol] ^{|Θ|} (5)

γ=f_{γ}( [symbol] (Θₙ₋₁), [symbol] )Θₙ₋₁+ΔΘₙ)),γ∈ [symbol] ^{|Θ|} (6)

LGD is a special case of Eq. 4, with λ=1, γ=0, and with no knowledge preserved across fitting iterations. gₙ is the gradient of the target data term w.r.t. to the problem parameters: gₙ=∇L^{D}.

The disclosed neural fitter satisfies the requirements (a), (b) and (c) above. The following describes how the requirements (d), (e), and (f) are satisfied.

(d): keeping track of past iterations. The functions f, f_{λ}, f_{γ} are implemented with a Gated Recurrent Unit (GRU), with layer normalization. Unlike existing methods, where the learned optimizer only stores past parameter values and the total loss, leveraging GRUs allows for the learning of an abstract representation of the knowledge that is important to use and forget about the previous iteration(s), and of the knowledge about the current iteration that should be preserved at the next iteration.

(e): independent learning rate. When fitting face or body models to data, the variables being optimized over are of a different nature. For instance, rotations might be expressed in Euler angles while translation is in meters. Since each of these parameters have a different scale and/or unit, it is useful to have per-parameter step size values. The disclosed embodiments predict vectors λ and γ independently to scale the relative contribution of ΔΘₙ and gₙ to the update applied to each entry of Θₙ. It is noted that f_{λ} having knowledge about the current value of residuals at Θₙ and the residual at Θₙ+ΔΘₙ, effectively makes use of an estimate of the step direction before setting a step size which is analogous to how line-search operates.

(f): combining gradient descent and network updates. Eq. 4 presents a mathematically simple yet powerful combination between network updates and gradient descent.

Example training losses: A loss is applied on the output of every step of the network:

[symbol]

({Θₙ}ₙ₌₀^{N}{\hat{Θ}ₙ}ₙ₌₀^{N};D)=Σᵢ₌₀^{N} [symbol] ᵢ(Θᵢ,\hat{Θ}ᵢ;D)

The loss L, contains the following terms:

[symbol]

ᵢ=λ_{M} [symbol] ᵢ^{M}+λ_{ε} [symbol] ᵢ^{ε}+λ_{T} [symbol] ᵢ^{T}+λ_{θ} [symbol] ᵢ^{θ}

[symbol]

ᵢ^{M}= [symbol] \hat{M}−M [symbol] ₁

[symbol]

ᵢ^{ε}=Σ_{(i,j)∈ε} [symbol] (\hat{M}ᵢ−\hat{M}ⱼ)−(Mᵢ−Mⱼ) [symbol] ₁

[symbol]

ᵢ^{T}=Σⱼ₌₁^{J} [symbol] (\hat{T}ⱼ−Tⱼ [symbol] ₁

[symbol]

ᵢ^{θ}= [symbol] \hat{R}_{θ}−R_{θ} [symbol] ₁+ [symbol] \hat{t}−t [symbol] ₁

As defined above, M represents the mesh vertices deformed by parameters Θ. ε is the set of vertex indices of the mesh edges. T denotes the transformations in world coordinates while R_{θ} denotes the rotation matrices (in the parent-relative coordinate frame) computed from the pose values θ. t is the root translation vector.

Example model structure: In an example, f, fλ, fγ (in Alg. 1, Eq. 5, Eq. 6) may use a stack of two GRUs with 1024 units each. The initialization Φ, Φₕ in Alg. 1 are MLPs with two layers of 256 units, ReLU and Batch Normalization.

Example datasets: For the body fitting tasks, AMASS may be used to train and test the fitters. When fitting SMPL to 2D keypoints, 3DPW's test set may be used to evaluate the learned fitter's accuracy. The face fitter may be trained and evaluated on synthetic data.

Referring to the appended drawings, in which like numerals represent like elements throughout the several FIGURES, aspects of various technologies for improved training data will be described. In the following detailed description, references are made to the accompanying drawings that form a part hereof, and which are shown by way of illustrating specific configurations or examples.

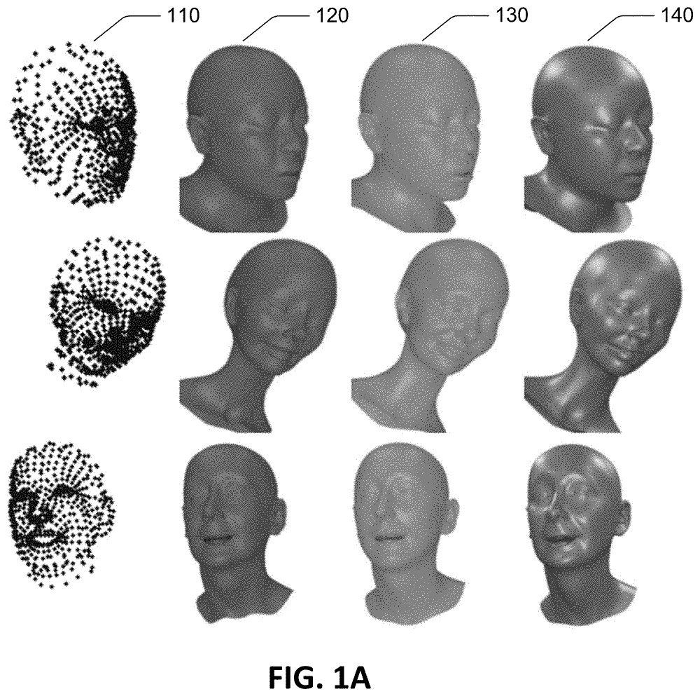

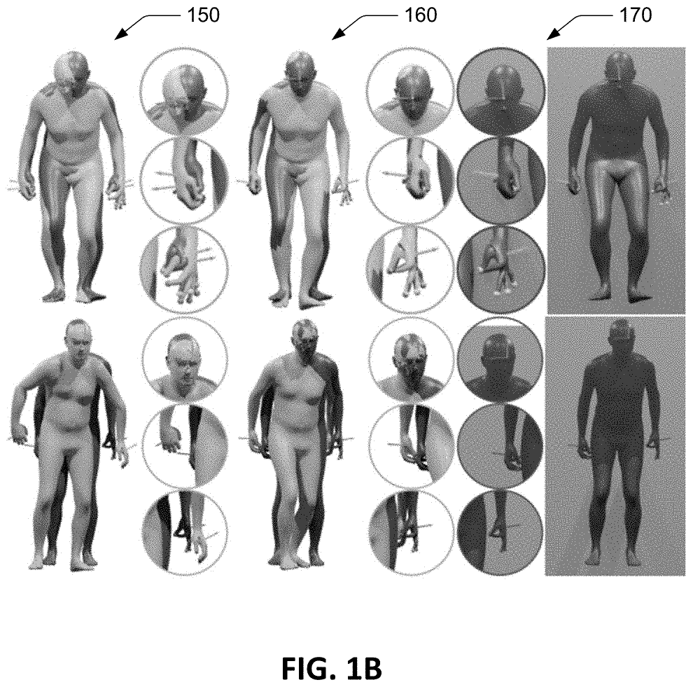

Turning to FIG. 1A, illustrated is an example of fitting the pose, expression, and identity parameters of a 3D face model to dense 2D landmarks: target 2D landmarks 110, LM fitter results 120, fitter result 130 according to the present disclosure, and ground-truth 140.

Turning to FIG. 1B, illustrated is an example of bodies estimated from HMD signals with the disclosed SMPL+H fitter (half-space visibility): Initial Φ output 150 (in yellow), iteration N=5 of the disclosed fitter (in yellow) 160, and ground-truth overlay 170 (in blue). Points that are greyed out are outside of the field of view, e.g., both hands in the second raw. The disclosed learned optimizer successfully fits the target head and hands data and produces plausible poses for the full 3D body. In the second row, hands are outside of the FOV and thus not perfectly fitted.

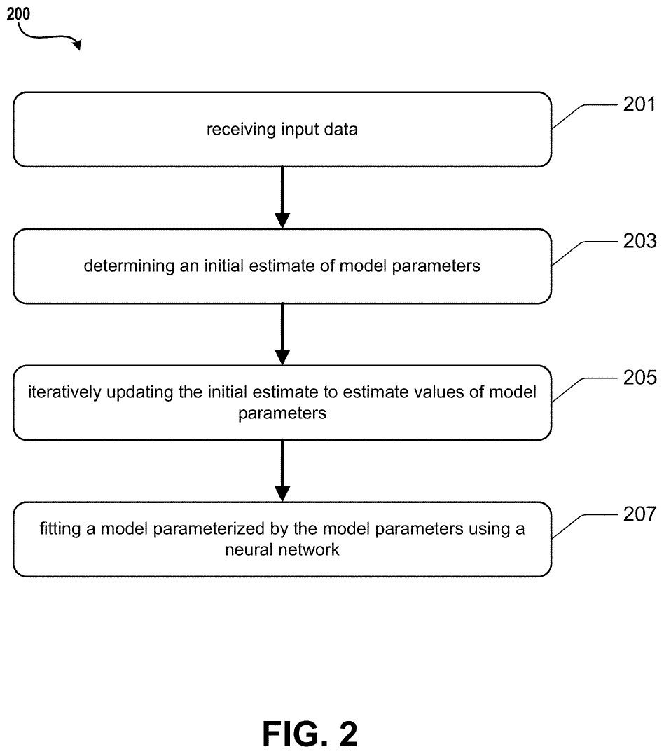

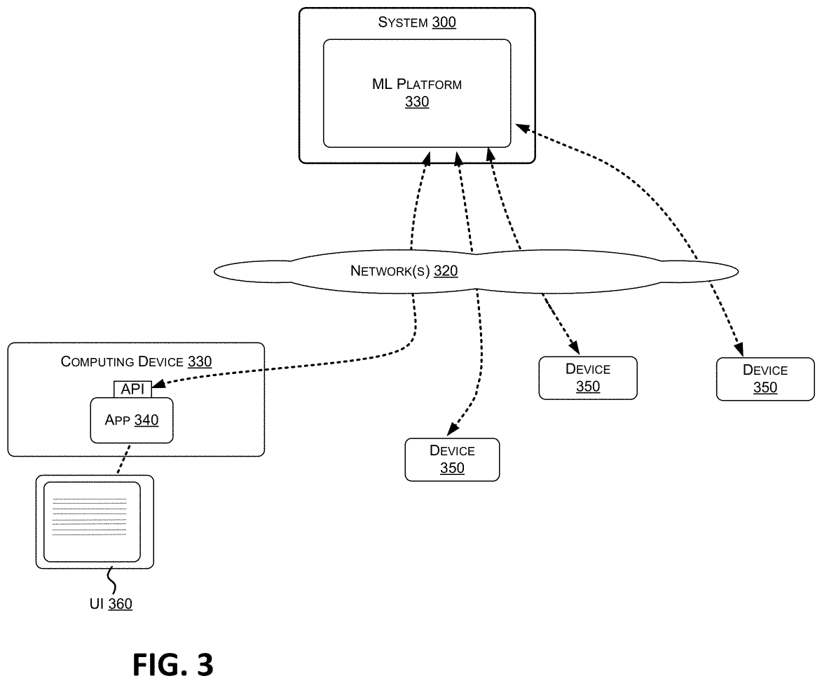

Turning now to FIG. 2, illustrated is an example operational procedure for in accordance with the present disclosure. Such an operational procedure may be provided by one or more components illustrated in FIGS. 3 through 6. The operational procedure may be implemented in a system comprising one or more computing devices. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

It should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof. Thus, although the routine 200 is described as running on a system, it can be appreciated that the routine 200 and other operations described herein can be executed on an individual computing device or several devices.

Referring to FIG. 2, operation 201 illustrates receiving input data D.

Operation 201 may be followed by operation 203. Operation 203 illustrates based on the input data D, determining an initial estimate of model parameters Θ₀.

Operation 203 may be followed by operation 205. Operation 205 illustrates using machine learning, iteratively updating the initial estimate Θ₀ to estimate values of model parameters Θ.

Operation 205 may be followed by operation 207. Operation 207 illustrates fitting a model parameterized by model parameters Θ using a neural network Φ.

In the example system illustrated in FIG. 3, a system 300 is illustrated that implements machine learning (ML) platform 330. The ML platform 330 may be configured to provide output data to various devices 350 over a network 320, as well as computing device 330. A user interface 360 may be rendered on computing device 333030. The user interface 360 may be provided in conjunction with an application 340 that communicates to the ML platform 330 using an API via network 320. In some embodiments, system 300 may be configured to provide product information to users. In one example, ML platform 330 may implement a machine learning system to perform one or more tasks. The ML platform 330 utilize the machine learning system to perform tasks such as image and writing recognition. The machine learning system may be configured to be optimized using the techniques described herein.

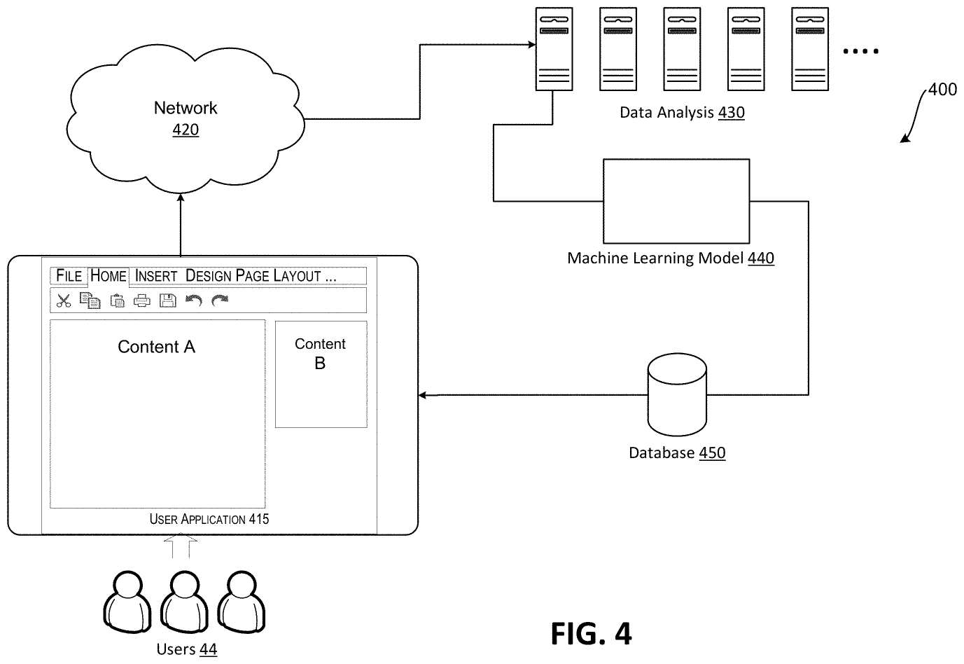

FIG. 4 is a computing system architecture diagram showing an overview of a system disclosed herein for implementing a machine learning model, according to one embodiment disclosed herein. As shown in FIG. 4, a machine learning system 400 may be configured to perform analysis and perform identification, prediction, or other functions based upon various data collected by and processed by data analysis components 430 (which might be referred to individually as an “data analysis component 430” or collectively as the “data analysis components 430”). The data analysis components 430 may, for example, include, but are not limited to, physical computing devices such as server computers or other types of hosts, associated hardware components (e.g., memory and mass storage devices), and networking components (e.g., routers, switches, and cables). The data analysis components 430 can also include software, such as operating systems, applications, and containers, network services, virtual components, such as virtual disks, virtual networks, and virtual machines. The database 450 can include data, such as a database, or a database shard (i.e., a partition of a database). Feedback may be used to further update various parameters that are used by machine learning model 420. Data may be provided to the user application 415 to provide results to various users 44 using a user application 415. In some configurations, machine learning model 420 may be configured to utilize supervised and/or unsupervised machine learning technologies. A model compression framework based on sparsity-inducing regularization optimization as disclosed herein can reduce the amount of data that needs to be processed in such systems and applications. Effective model compression when processing iterations over large amounts of data may provide improved latencies for a number of applications that use such technologies, such as image and sound recognition, recommendation systems, and image analysis.

The various aspects of the disclosure are described herein with regard to certain examples and embodiments, which are intended to illustrate but not to limit the disclosure. It should be appreciated that the subject matter presented herein may be implemented as a computer process, a computer-controlled apparatus, or a computing system or an article of manufacture, such as a computer-readable storage medium. While the subject matter described herein is presented in the general context of program modules that execute on one or more computing devices, those skilled in the art will recognize that other implementations may be performed in combination with other types of program modules. Generally, program modules include routines, programs, components, data structures and other types of structures that perform particular tasks or implement particular abstract data types.

Those skilled in the art will also appreciate that the subject matter described herein may be practiced on or in conjunction with other computer system configurations beyond those described herein, including multiprocessor systems. The embodiments described herein may also be practiced in distributed computing environments, where tasks are performed by remote processing devices that are linked through a communications network. In a distributed computing environment, program modules may be located in both local and remote memory storage devices.

Networks established by or on behalf of a user to provide one or more services (such as various types of cloud-based computing or storage) accessible via the Internet and/or other networks to a distributed set of clients may be referred to as a service provider.

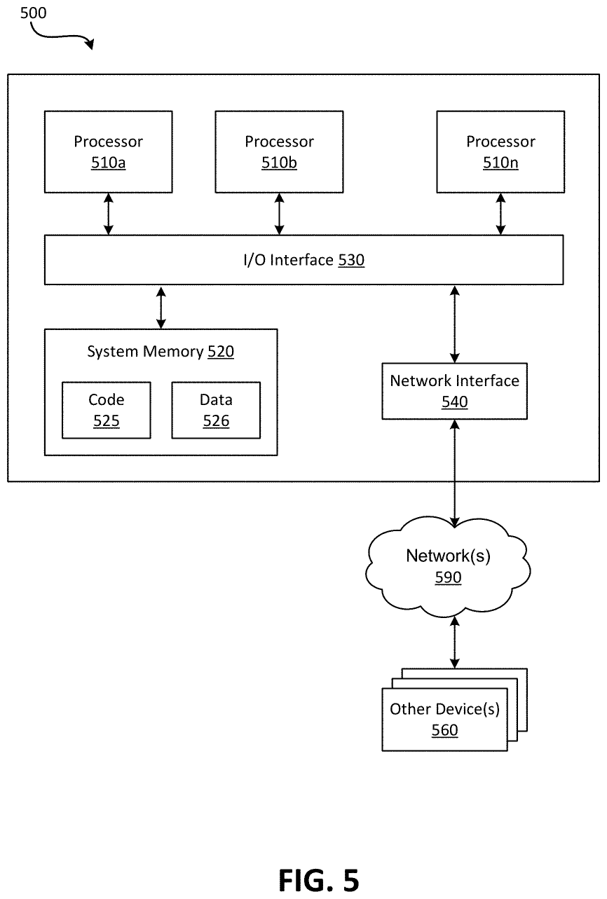

In some embodiments, a server that implements a portion or all of one or more of the technologies described herein, including the techniques to implement methods for predicting keypoints in an image may include a general-purpose computer system that includes or is configured to access one or more computer-accessible media. FIG. 5 illustrates such a general-purpose computing device 500. In the illustrated embodiment, computing device 500 includes one or more processors 510a, 510b, and/or 510n (which may be referred herein singularly as “a processor 510” or in the plural as “the processors 510”) coupled to a system memory 520 via an input/output (I/O) interface 530. Computing device 500 further includes a network interface 540 coupled to I/O interface 530.

In various embodiments, computing device 500 may be a uniprocessor system including one processor 510 or a multiprocessor system including several processors 510 (e.g., two, four, eight, or another suitable number). Processors 510 may be any suitable processors capable of executing instructions. For example, in various embodiments, processors 510 may be general-purpose or embedded processors implementing any of a variety of instruction set architectures (ISAs), such as the x56, PowerPC, SPARC, or MIPS ISAs, or any other suitable ISA. In multiprocessor systems, each of processors 510 may commonly, but not necessarily, implement the same ISA.

System memory 520 may be configured to store instructions and data accessible by processor(s) 510. In various embodiments, system memory 520 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those methods, techniques and data described above, are shown stored within system memory 520 as code 525 and data 526.

In one embodiment, I/O interface 530 may be configured to coordinate I/O traffic between the processor 510, system memory 520, and any peripheral devices in the device, including network interface 540 or other peripheral interfaces. In some embodiments, I/O interface 530 may perform any necessary protocol, timing, or other data transformations to convert data signals from one component (e.g., system memory 520) into a format suitable for use by another component (e.g., processor 510). In some embodiments, I/O interface 530 may include support for devices attached through various types of peripheral buses, such as a variant of the Peripheral Component Interconnect (PCI) bus standard or the Universal Serial Bus (USB) standard, for example. In some embodiments, the function of I/O interface 530 may be split into two or more separate components. Also, in some embodiments some or all of the functionality of I/O interface 530, such as an interface to system memory 520, may be incorporated directly into processor 510.

Network interface 540 may be configured to allow data to be exchanged between computing device 500 and other device or devices 560 attached to a network or network(s) 590, such as other computer systems or devices as illustrated in FIGS. 1 through 7, for example. In various embodiments, network interface 540 may support communication via any suitable wired or wireless general data networks, such as types of Ethernet networks, for example. Additionally, network interface 540 may support communication via telecommunications/telephony networks such as analog voice networks or digital fiber communications networks, via storage area networks such as Fibre Channel SANs or via any other suitable type of network and/or protocol.

In some embodiments, system memory 520 may be one embodiment of a computer-accessible medium configured to store program instructions and data as described above for FIGS. 1-10 for implementing embodiments of the corresponding methods and apparatus. However, in other embodiments, program instructions and/or data may be received, sent or stored upon different types of computer-accessible media. A computer-accessible medium may include non-transitory storage media or memory media, such as magnetic or optical media, e.g., disk or DVD/CD coupled to computing device 500 via I/O interface 530. A non-transitory computer-accessible storage medium may also include any volatile or non-volatile media, such as RAM (e.g. SDRAM, DDR SDRAM, RDRAM, SRAM, etc.), ROM, etc., that may be included in some embodiments of computing device 500 as system memory 520 or another type of memory. Further, a computer-accessible medium may include transmission media or signals such as electrical, electromagnetic or digital signals, conveyed via a communication medium such as a network and/or a wireless link, such as may be implemented via network interface 540. Portions or all of multiple computing devices, such as those illustrated in FIG. 5, may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device,” as used herein, refers to at least all these types of devices and is not limited to these types of devices.

Various storage devices and their associated computer-readable media provide non-volatile storage for the computing devices described herein. Computer-readable media as discussed herein may refer to a mass storage device, such as a solid-state drive, a hard disk or CD-ROM drive. However, it should be appreciated by those skilled in the art that computer-readable media can be any available computer storage media that can be accessed by a computing device.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computing devices discussed herein. For purposes of the claims, the phrase “computer storage medium,” “computer-readable storage medium” and variations thereof, does not include waves, signals, and/or other transitory and/or intangible communication media, per se.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the disclosed computing devices in order to store and execute the software components and/or functionality presented herein. It is also contemplated that the disclosed computing devices may not include all of the illustrated components shown in FIG. 5, may include other components that are not explicitly shown in FIG. 5, or may utilize an architecture completely different than that shown in FIG. 5.

Although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated any reference to “first,” “second,” etc. items and/or abstract concepts within the description is not intended to and should not be construed to necessarily correspond to any reference of “first,” “second,” etc. elements of the claims. In particular, within this Summary and/or the following Detailed Description, items and/or abstract concepts such as, for example, individual computing devices and/or operational states of the computing cluster may be distinguished by numerical designations without such designations corresponding to the claims or even other paragraphs of the Summary and/or Detailed Description. For example, any designation of a “first operational state” and “second operational state” of the computing cluster within a paragraph of this disclosure is used solely to distinguish two different operational states of the computing cluster within that specific paragraph—not any other paragraph and particularly not the claims.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

The disclosure presented herein also encompasses the subject matter set forth in the following clauses:

Clause 1: A method for fitting a model using observation data, the method comprising:
receiving input data D;
based on the input data D, determining an initial estimate of model parameters Θ₀;
using machine learning, iteratively updating the initial estimate Θ₀ to estimate values of model parameters Θ; and
fitting a model parameterized by the values of the model parameters Θ using a neural network Φ.

Clause 2: The method of clause 1, wherein the input data is one of a sparse 3D observation or a sparse 2D observation.

Clause 3: The method of any of clauses 1-2, wherein the input data is one of a sparse 2D observation or a dense 2D observation.

Clause 4: The method of any of clauses 1-3, wherein the iteratively updating comprises: at an n-th iteration, using a neural network f to predict additive updates in parameter value) Θₙ₊₁=Θₙ+ΔΘₙ.

Clause 5: The method of any of clauses 1-4, wherein the iteratively updating comprises determining the following until converged:
a gradient of an optimization function for the model; and
characteristics based on the optimization function.

Clause 6: The method of any of clauses 1-5, wherein:
the gradient is gₙ₋₁ in ΔΘₙ, hₙ←f([gₙ₋₁, Θₙ₋₁], D, hₙ₋₁); and

Θₙ←Θₙ₋₁+u(ΔΘₙ,gₙ₋₁,Θₙ₋₁).

Clause 7: The method of clauses 1-6, wherein the iteratively updating comprises applying an update rule that combines information pertaining to a prediction by the model and a confidence factor.

Clause 8: The method of any of clauses 1-7, wherein the update rule comprises:

u(ΔΘₙ,gₙ₋₁,Θₙ₋₁)=λΔΘₙ+(−γgₙ₋₁).

Clause 9: The method of clauses 1-8, further comprising applying a loss on each output:

[symbol]

({Θₙ}ₙ₌₀^{N},{\hat{Θ}ₙ}ₙ₌₀^{N};D)=Σᵢ₌₀^{N} [symbol] ᵢ(Θᵢ,\hat{Θ}ᵢ;D).

Clause 10: The method of clauses 1-9, wherein the input data is of a face, hand, or body.

Clause 11: A computing system for fitting a model using observation data, the computing system comprising:
one or more processors; and
a computer-readable storage medium having computer-executable instructions stored thereupon which, when executed by the processor, cause the computing system to perform operations comprising:
receiving input data D;
based on the input data D, determining an initial estimate of model parameters Θ₀,
using machine learning, iteratively updating the initial estimate Θ₀ to estimate values of model parameters Θ; and
fitting a model parameterized by the values of the model parameters Θ using a neural network Φ.

Clause 12: The system of clause 11, wherein the iteratively updating comprises: at an n-th iteration, using a neural network f to predict additive updates in parameter value) Θₙ₊₁=Θₙ+ΔΘₙ.

Clause 13: The system of any of clauses 11 and 12, wherein the iteratively updating comprises determining the following until converged:
a gradient of an optimization function for the model; and
characteristics based on the optimization function.

Clause 14: The system of any clauses 11-13, wherein the iteratively updating comprises applying an update rule that combines information pertaining to a prediction by the model and a confidence factor.

Clause 15: The system of any clauses 11-14, further comprising applying a loss on each output:

[symbol]

({Θₙ}ₙ₌₀^{N},{\hat{Θ}ₙ}ₙ₌₀^{N};D)=Σᵢ₌₀^{N} [symbol] ᵢ(Θᵢ,\hat{Θ}ᵢ;D).

Clause 16: A computer-readable storage medium having computer-executable instructions stored thereupon which, when executed by one or more processors of a computing device, cause the computing device to perform operations for fitting a model using observation data, the operations comprising:
receiving input data D;
based on the input data D, determining an initial estimate of model parameters Θ₀,
using machine learning, iteratively updating the initial estimate Θ₀ to estimate values of model parameters Θ; and
fitting a model parameterized by the values of the model parameters Θ using a neural network Φ.

Clause 17: The computer-readable storage medium of clause 16, wherein the iteratively updating comprises: at an n-th iteration, using a neural network f to predict additive updates in parameter value) Θₙ₊₁=Θₙ+ΔΘₙ.

Clause 18: The computer-readable storage medium of any of clauses 16 and 17, wherein the iteratively updating comprises determining the following until converged:
a gradient of an optimization function for the model; and
characteristics based on the optimization function.

Clause 19: The computer-readable storage medium of any of the clauses 16-18, wherein the iteratively updating comprises applying an update rule that combines information pertaining to a prediction by the model and a confidence factor.

Clause 20: The computer-readable storage medium of any of the clauses 16-19, wherein the input data is of a face, hand, or body.

What is claimed is:

1. A method for fitting a model using observation data, the method comprising:
receiving input data D;
based on the input data D, determining an initial estimate of model parameters Θ₀,
using machine learning, iteratively updating the initial estimate Θ₀ to estimate values of model parameters Θ; and
fitting a model parameterized by the values of the model parameters Θ using a neural network Φ.

2. The method of claim 1, wherein the input data is one of a sparse 3D observation or a sparse 2D observation.

3. The method of claim 1, wherein the input data is one of a sparse 2D observation or a dense 2D observation.

4. The method of claim 1, wherein the iteratively updating comprises: at an n-th iteration, using a neural network f to predict additive updates in parameter value) Θₙ₊₁=Θₙ+ΔΘₙ.

5. The method of claim 1, wherein the iteratively updating comprises determining the following until converged:
a gradient of an optimization function for the model; and
characteristics based on the optimization function.

6. The method of claim 5, wherein:
the gradient is gₙ₋₁ in ΔΘₙ, hₙ←f([gₙ₋₁, Θₙ₋₁], D, hₙ₋₁); and
Θₙ←Θₙ₋₁+u(ΔΘₙ,gₙ₋₁,Θₙ₋₁).

7. The method of claim 1, wherein the iteratively updating comprises applying an update rule that combines information pertaining to a prediction by the model and a confidence factor.

8. The method of claim 7, wherein the update rule comprises:
u(ΔΘₙ,gₙ₋₁,Θₙ₋₁)=λΔΘₙ+(−γgₙ₋₁).

9. The method of claim 1, further comprising applying a loss on each output: [symbol]
({Θₙ}ₙ₌₀^{N},{\hat{Θ}ₙ}ₙ₌₀^{N};D)=Σᵢ₌₀^{N} [symbol] ᵢ(Θᵢ,\hat{Θ}ᵢ;D).

10. The method of claim 1, wherein the input data is of a face, hand, or body.

11. A computing system for fitting a model using observation data, the computing system comprising:
one or more processors; and
a computer-readable storage medium having computer-executable instructions stored thereupon which, when executed by the processor, cause the computing system to perform operations comprising:
receiving input data D;
based on the input data D, determining an initial estimate of model parameters Θ₀;
using machine learning, iteratively updating the initial estimate Θ₀ to estimate values of model parameters Θ; and
fitting a model parameterized by the values of the model parameters Θ using a neural network Φ.

12. The computing system of claim 11, wherein the iteratively updating comprises: at an n-th iteration, using a neural network f to predict additive updates in parameter value) Θₙ₊₁=Θₙ+ΔΘₙ.

13. The computing system of claim 11, wherein the iteratively updating comprises determining the following until converged:
a gradient of an optimization function for the model; and
characteristics based on the optimization function.

14. The computing system of claim 11, wherein the iteratively updating comprises applying an update rule that combines information pertaining to a prediction by the model and a confidence factor.

15. The computing system of claim 11, further comprising applying a loss on each output: [symbol]
({Θₙ}ₙ₌₀^{N},{\hat{Θ}ₙ}ₙ₌₀^{N};D)=Σᵢ₌₀^{N} [symbol] ᵢ(Θᵢ,\hat{Θ}ᵢ;D).

16. A computer-readable storage medium having computer-executable instructions stored thereupon which, when executed by one or more processors of a computing device, cause the computing device to perform operations for fitting a model using observation data, the operations comprising:
receiving input data D;
based on the input data D, determining an initial estimate of model parameters Θ₀;
using machine learning, iteratively updating the initial estimate Θ₀ to estimate values of model parameters Θ; and
fitting a model parameterized by the values of the model parameters Θ using a neural network Φ.

17. The computer-readable storage medium of claim 16, wherein the iteratively updating comprises: at an n-th iteration, using a neural network f to predict additive updates in parameter value) Θₙ₊₁=Θₙ+ΔΘₙ.

18. The computer-readable storage medium of claim 16, wherein the iteratively updating comprises determining the following until converged:
a gradient of an optimization function for the model; and
characteristics based on the optimization function.

19. The computer-readable storage medium of claim 16, wherein the iteratively updating comprises applying an update rule that combines information pertaining to a prediction by the model and a confidence factor.

20. The computer-readable storage medium of claim 16, wherein the input data is of a face, hand, or body.
